(19) United States
(12) Patent Application Publication
(10) Pub. No.: US 2009/0056323 A1
(43) Pub. Date: Mar. 5, 2009

(54) Method for forming a rim on a torque converter

(75) Inventors: Herbert Wolf, Wooster, OH (US); Timothy Simon, Wooster, OH (US); Mark Kollert, Wooster, OH (US)

Correspondence Address: SIMPSON & SIMPSON, PLLC, 5555 MAIN STREET, WILLIAMSVILLE, NY, 14221-5406, US

(73) Assignee: LuK Lamellen and Kupplungsbau Beteiligungs KG, Buehl (DE)

(21) Appl. No.: 12/229,226

(22) Filed: Aug. 21, 2008

Related U.S. Application Data
(60) Provisional application No. 60/966,990, filed on Aug. 31, 2007.

(51) Int. Cl. F16H 41/24; B23P 15/00; F16D 33/18

(52) U.S. Cl. 60/364; 29/889.5; 72/324

(57) ABSTRACT

A ring portion of a torque converter shell having a first segment at a distal end of the ring portion, a second segment at a second end of the ring portion adjacent an annular portion of the shell, and a ribbed portion located axially between the first segment and the second segment, and extending in a radial direction beyond the first and second segments.

### CROSS REFERENCE TO RELATED APPLICATIONS

This patent application claims the benefit under 35 U.S.C. §119(e) of U.S. Provisional Application No. 60/966,990, filed Aug. 31, 2007, which application is incorporated herein by reference.

### FIELD OF THE INVENTION

The invention relates generally to torque converters, and more specifically to a method for forming a rim on a torque converter shell.

### BACKGROUND OF THE INVENTION

A mating connection between a cover and pump for a torque converter must be held to tight tolerances to accommodate joining of the components to prevent leakage. Machining of the interface between the cover and the pump is necessary to assure proper tolerances when normal stamping practices are employed to produce the cover and pump. Machining is expensive because it is an additional step in the manufacturing process.

U.S. Pat. No. 6,024,538 (Tanishiki et al.) describes an impeller shell formed by a multiple step press forming process including a first step of initial forming and a second step of forming by a plurality of dies including a first die surface extending substantially parallel to the central axis of the torque converter for forming the inner peripheral surface of the main portion, and a second die surface extending perpendicular to the first die surface and parallel to the plane B for forming the inner surface of the stepped portion. The forming of the interface between the cover the pump is not addressed.

U.S. Pat. No. 6,769,522 (Kawamoto et al.) describes a method of manufacturing the front cover of a fluid-type torque transmission device with a lockup clutch. The device is provided with a front cover, a turbine, a pump impeller, and a lockup clutch. The front cover is fixed to an input shaft. The turbine is connected to an output shaft. The pump impeller is connected by welding to the front cover. The lockup clutch has a facing part for sliding against the front cover. The method has a step for making the wall thickness of the region containing the welding part thinner than the wall thickness of the region containing the connection part. Thus, the rigidity of the region containing the welding part is purposefully less than the rigidity of the region containing the connection part to alleviate waviness of the sliding contact surface in the circumferential direction. This design does not purport to eliminate the necessity of machining the welding area.

Thus there is a long-felt need for an improved cover design whereby a secondary machining operation is eliminated. There is also a need for a stamping process that eliminates the machining operation.

### BRIEF SUMMARY OF THE INVENTION

The present invention broadly comprises a ring portion of a torque converter shell having a first segment at a distal end of the ring portion, a second segment at a second end of the ring portion adjacent an annular portion of the shell, and a ribbed portion located axially between the first segment and the second segment, and extending in a radial direction beyond the first and second segments. In one embodiment, the ribbed portion extends radially inward. In another embodiment, the ribbed portion extends radially outward.

In one embodiment, the shell is a cover shell for the torque converter. In another embodiment, the shell is a pump shell for the torque converter. In a further embodiment, the first segment is thinner than the second segment. In yet another embodiment, the shell is a cover shell for the torque converter, the ribbed portion extends radially inward, and the first segment is thinner than the second segment. In still a further embodiment, the shell is a pump shell for the torque converter, the ribbed portion extends radially outward, and the first segment is thinner than said second segment.

The present invention also broadly comprises a torque converter with a pump shell having an outer ring with a ribbed portion extending radially from the ring, a cover shell having an outer ring with a ribbed portion extending radially from the ring, and a turbine, and the pump shell outer ring and the cover shell outer ring axially overlap when the torque converter is assembled. In one embodiment, at least one of the cover shell ribbed portion or the pump shell ribbed portion is used as filler material for an autogenous welding process joining the pump shell and the cover shell. In another embodiment, the torque converter includes a drive plate and the drive plate is attached to the cover shell by riveting. In a further embodiment, the cover shell has extruded rivets and the riveting attachment uses the extruded rivets.

The present invention also broadly comprises a method for manufacturing a torque converter shell with the steps of forming an outer ring portion in an axial direction; and reducing a thickness of a distal end of the ring portion by shearing in an axial direction. In one embodiment, the shell is a cover shell. In another embodiment, the shell is a pump shell. In yet another embodiment, the shearing creates a rib extending radially from the ring portion.

In one embodiment, the shearing is accomplished with a die having a sharp corner in contact with the distal end. In another embodiment, an inner diameter of the die is less than an outer diameter of the ring portion and the rib extends radially outward. In yet another embodiment, an outer diameter of the die is greater than an inner diameter of the ring portion and the rib extends radially inward. In a further embodiment, a surface of the rib adjacent to the distal end is substantially perpendicular to an axis of the ring portion.

In another embodiment, a shearing block is arranged with respect to the shell so that material is sheared off an outer surface of the shell, resulting in the rib extending radially outward with respect to the shell. In another embodiment, a shearing block is arranged with respect to the shell so that material is sheared off an inner surface of the shell, resulting in the rib extending radially inward with respect to the shell.

It is a general object of the present invention to provide a stamped torque converter shell with improved roundness that does not require a secondary machining operation.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is half cross sectional view of a torque converter assembly;

FIG. 2 is an enlarged view of encircled region 2 of FIG. 1;

FIG. 3 is a cross section of a stamping die used to form a ring portion of a torque converter shell according to the current invention; and,

FIG. 4 is a cross section of a stamping die used to shear a thinned portion of the ring portion of FIG. 3;

FIG. 5A is a perspective view of a cylindrical coordinate system demonstrating spatial terminology used in the present application; and,

FIG. 5B is a perspective view of an object in the cylindrical coordinate system of FIG. 1A demonstrating spatial terminology used in the present application.

### DETAILED DESCRIPTION OF THE INVENTION

At the outset, it should be appreciated that like drawing numbers on different drawing views identify identical, or functionally similar, structural element of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

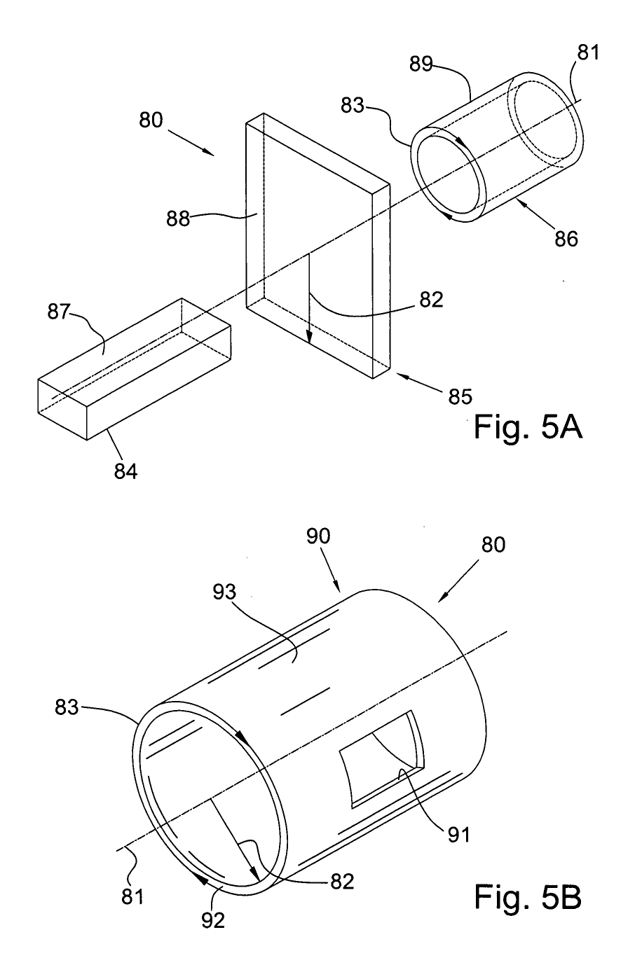

FIG. 5A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 5B is a perspective view of object 90 in cylindrical coordinate system 80 of FIG. 5A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

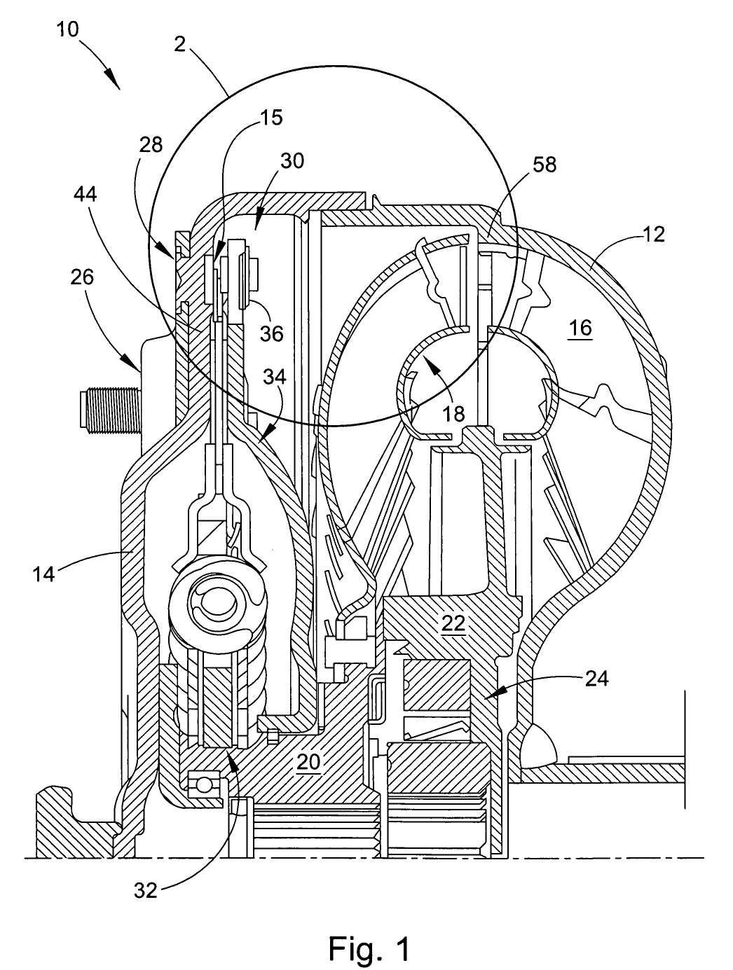

FIG. 1 shows a cross-sectional view of a top half of torque converter assembly 10. It should be appreciated that the bottom half of the torque converter assembly is substantially a mirror image of the shown top half. The following should be read in light of FIG. 1. Assembly 10 includes pump shell 12 and cover shell 14. Pump blades located in pump 16 are attached to pump shell 12 to propel fluid to turbine assembly 18. Turbine assembly 18 is connected to hub 20 which is in turn splined to a transmission shaft (not shown). Stator 22 is engaged with a stator shaft (not shown) through one-way clutch assembly 24.

Drive plate 26 is attached to cover shell 14. In a preferred embodiment, rivets 28 extruded from cover shell 14 are used to attach drive plate 26. Clutch assembly 30 is drivingly engaged with hub 20 at spline 32. Clutch assembly 30 includes piston plate 34 attached to cover shell 14. Piston plate 34 is attached to cover shell 14 using leaf springs 36 and rivets (not shown) extruded from cover shell 14. In traditional torque converters, welds would be used to attach cover shell 14 and drive plate 26, instead of rivets 28. However, welding creates distortion on surface 15 of the cover shell, opposite from the drive plate. This surface engages with clutch assembly 30, and therefore must be flat and smooth to function properly. Therefore, prior art torque converters which include drive plates welded to cover shells must undergo a machining process to flatten out the surface 15 which engages with the clutch assembly. Since a primary purpose of the current invention is to remove extraneous machining operations, rivets 28 enable drive plate 26 and cover shell 14 to be sufficiently connected together without requiring any additional machining.

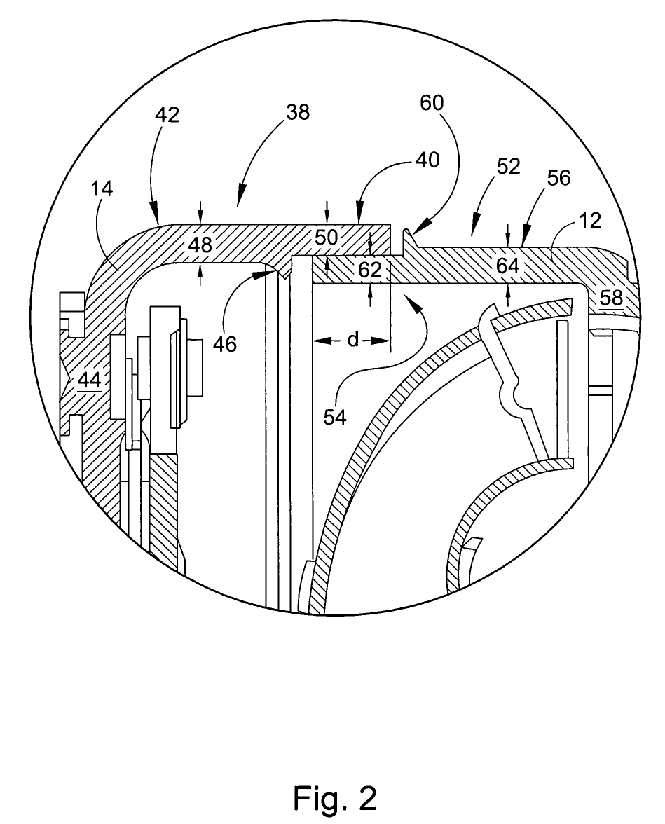

FIG. 2 is an enlarged view of encircled region 2 in FIG. 1. The following should be read in light of FIGS. 1-2. Cover shell 14 includes ring portion 38. Ring portion 38 includes first segment 40 at a distal end of ring portion 38 and second segment 42 at an end of ring portion 38 adjacent annular portion 44 of shell 14. Ring portion 38 further includes ribbed portion 46 located axially between first segment 40 and second segment 42, and extending in a radial direction beyond segments 40 and 42. By extending in a radially direction beyond, we mean that in one embodiment ribbed portion 46 extends radially inward, while in an alternate embodiment ribbed portion 46 extends radially outward. In a preferred embodiment, thickness 48 of segment 40 is greater than thickness 50 of segment 42, but it should be understood that this does not necessarily have to be the case.

Pump shell 12 includes ring portion 52. Ring portion 52 includes first segment 54 at a distal end of ring portion 52 and second segment. 56 at end of ring portion 52 adjacent annular portion 58 of shell 12. Ring portion 52 further includes ribbed portion 60 located axially between first segment 54 and second segment 56, and extending in a radial direction beyond segments 54 and 56. In the shown embodiment, ribbed portion 60 extends radially outward. Also in a preferred embodiment, thickness 62 of segment 54 is less than thickness 64 of segment 56.

It should be appreciated that in a preferred embodiment ribbed portion 46 extends radially inward and ribbed portion 60 extends radially outward, as cover shell 14 overlaps on top of, or outside of, pump shell 12. However, in an alternate embodiment, pump shell 12 could overlap outside of cover shell 14 so that ribbed portion 46 radially extends outward, while ribbed portion 60 extends radially inward.

In a preferred embodiment, pump shell 12 includes outer ring 52 with ribbed portion 60 extending radially from ring 52, cover shell 14 includes outer ring 38 with ribbed portion 46 extending radially from ring 38, while pump shell outer ring 52 and cover shell outer ring 38 axially overlap when torque converter 10 is assembled, as indicated by distance d. In a preferred embodiment, at least one of cover shell ribbed portion 46 or pump shell ribbed portion 60 is used as filler material for an autogenous welding process joining pump shell 12 and cover shell 14.

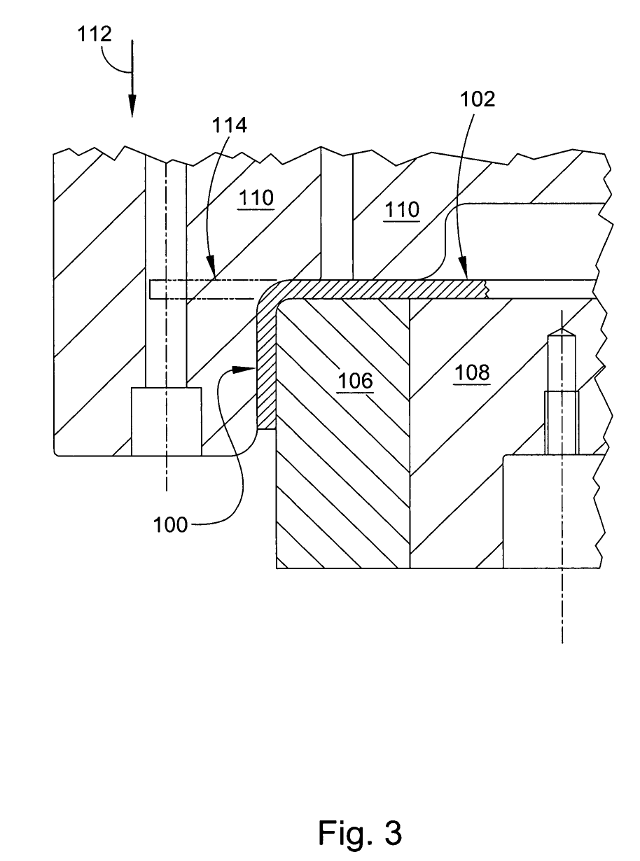

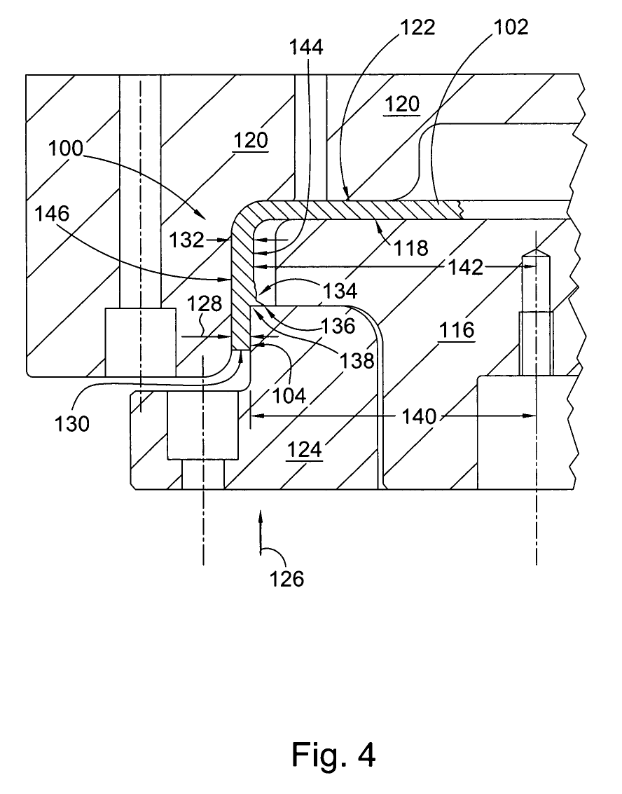

FIG. 3 is a cross section of a stamping die used to form ring portion 100 of torque converter shell 102. FIG. 4 is a cross section of a stamping die used to shear thinned portion 104 of ring portion 100. The following should be viewed in light of FIGS. 3 and 4. Blocks 106 and 108 support shell 102 as die 110 moves in direction 112 to form ring portion 100 in an axial direction. That is, outer diameter of shell 102 is substantially flat as depicted by phantom segment 114 before being formed by die 110. After forming, the roundness of ring portion 100 is limited due to stretching of portion 114 during forming.

After forming shell 102, as shown in FIG. 3, the shell undergoes the process illustrated in FIG. 4. Block 116 supports lower side 118 of shell 102 and block 120 supports upper side 122 of shell 102. Shearing block 124 moves in direction 126 to axially displace material from ring portion 100. That is, block 124 reduces thickness 128 of distal end 130 of ring portion 100 by shearing in an axial direction, so thickness 128 of distal end 130 is less than thickness 132 of the unsheared ring portion.

During the shearing process, displaced material sometimes forms burr or rib 134 with flat portion 136 in contact with block 124. In the shown embodiment, flat portion 136 is substantially perpendicular to an axis (not shown) of the ring portion. Also in the shown embodiment, block 124 has sharp corner 138 to enhance shearing ability of block 124. In one embodiment, shell 102 is a pump shell for a torque converter, similar to pump shell 12 in FIGS. 1 and 2. Likewise, in another embodiment, shell 102 could alternatively be a cover shell for a torque converter, similar to cover shell 14 shown in FIGS. 1 and 2. Thus, burr or rib 134 could be substantially equivalent to either ribbed portion 46 or ribbed portion 60, depending on if the process shown in FIGS. 3 and 4 produces a cover shell or a pump shell, respectively. Likewise, distal end 130 could be substantially equivalent to distal ends 40 or 54.

In the shown embodiment of the current invention, outer radius 140 of block 124 is greater than inner radius 142 of ring portion 100 and rib 134 is formed extending radially inward. Alternatively stated, shearing block 124 is arranged with respect to block 120 and shell 102 so that material is sheared off inner surface 144 of shell 102, resulting in rib 134 extending radially inward with respect to shell 102. In another embodiment (not shown), an inner diameter of the shearing block is less than an outer diameter of the ring portion and the rib is formed extending radially outward. Alternatively stated, shearing block 124 is arranged with respect to block 120 and shell 102 so that material is sheared off outer surface 146 of shell 102, resulting in rib 134 extending radially outward with respect to shell 102.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What we claim is:

1. A ring portion of a torque converter shell comprising:
a first segment at a distal end of said ring portion;
a second segment at a second end of said ring portion adjacent an annular portion of said shell; and,
a ribbed portion located axially between said first segment and said second segment, and extending in a radial direction beyond said first and second segments.

2. The ring portion of claim 1 wherein said ribbed portion extends radially inward.

3. The ring portion of claim 1 wherein said ribbed portion extends radially outward.

4. The ring portion of claim 1 wherein said shell is a cover shell for said torque converter.

5. The ring portion of claim 1 wherein said shell is a pump shell for said torque converter.

6. The ring portion of claim 1 wherein said first segment is thinner than said second segment.

7. The ring portion of claim 1 wherein said shell is a cover shell for said torque converter, said ribbed portion extends radially inward, and said first segment is thinner than said second segment.

8. The ring portion of claim 1 wherein said shell is a pump shell for said torque converter, said ribbed portion extends radially outward, and said first segment is thinner than said second segment.

9. A torque converter comprising:
a pump shell including an outer ring with a ribbed portion extending radially from said ring;
a cover shell including an outer ring with a ribbed portion extending radially from said ring;
a turbine; and,
wherein said pump shell outer ring and said cover shell outer ring axially overlap when said torque converter is assembled.

10. The torque converter of claim 9 wherein at least one of said cover shell ribbed portion or said pump shell ribbed portion is used as filler material for an autogenous welding process joining said pump shell and said cover shell.

11. The torque converter of claim 9 further comprising a drive plate and wherein said drive plate is attached to said cover shell by riveting.

12. The torque converter of claim 11 wherein said cover shell further comprises extruded rivets and said attachment of said drive plate to said cover shell is accomplished by use of said extruded rivets.

13. A method for manufacturing a torque converter shell comprising the steps of:
forming an outer ring portion in an axial direction; and
reducing a thickness of a distal end of said ring portion by shearing in said axial direction.

14. The method of claim 13 wherein said shell is a cover shell.

15. The method of claim 13 wherein said shell is a pump shell.

16. The method of claim 13 wherein said shearing creates a rib extending radially from said ring portion.

17. The method of claim 16 wherein said shearing is accomplished with a die having a sharp corner in contact with said distal end.

18. The method of claim 17 wherein an inner radius of said die is less than an outer radius of said ring portion and said rib is formed extending radially outward.

19. The method of claim 17 wherein an outer radius of said die is greater than an inner radius of said ring portion and said rib is formed extending radially inward.

20. The method of claim 16 wherein a surface of said rib adjacent said distal end is substantially perpendicular to an axis of said ring portion.

21. The method of claim 16 wherein a shearing block is arranged with respect to said shell so that material is sheared off an outer surface of said shell, resulting in said rib extending radially outward with respect to said shell.

22. The method of claim 16 wherein a shearing block is arranged with respect to said shell so that material is sheared off an inner surface of said shell, resulting in said rib extending radially inward with respect to said shell.
